(19) United States
(12) Patent Application Publication
(10) Pub. No.: US 2011/0240458 A1
(43) Pub. Date: Oct. 6, 2011

(54) Stripping column and process for extracting a component from a liquid medium

(75) Inventors: Thierry Cartage, Brussels (BE); Andrea Salto, Bahia Blanca (AR); Pedro Ribeiro, Ribeirao Pires (BR)

(73) Assignee: SOLVAY SA, Brussels (BE)

(21) Appl. No.: 13/132,612

(22) PCT Filed: Dec. 15, 2009
(86) PCT No.: PCT/EP09/67140

§ 371 Date: Jun. 3, 2011

(30) Foreign Application Priority Data
Dec. 22, 2008 (FR) 08.58915

(51) Int. Cl. B01D 3/22; B01D 3/40

(52) U.S. Cl. 203/49; 261/148

(57) ABSTRACT

Stripping column and process for extracting a component from a liquid medium using a gas, the stripping column comprising a vertical column (10) comprising an essentially cylindrical wall (54), the vertical column (10) being divided by horizontal perforated plates (20) into a series of superposed chambers (11, 12, . . . , 16, 17), each chamber (11, 12, . . . , 16, 17) comprising several vertical partitions (34, 34^{I}, 34^{II}, 34^{III}, 34^{IV}, 34^{V}) positioned so as to form chicanes. According to one important aspect of the invention, the vertical partitions (34, 34^{I}, 34^{II}, 34^{III}, 34^{IV}, 34^{V}) are attached to the wall (54) of the vertical column (10) and are designed so as to hold the perforated plates (20).

The present invention relates to a stripping column for extracting a component from a liquid medium using a gas, in particular for extracting a monomer from an aqueous polymer slurry.

Suspension polymerization is a technique that is commonly used to manufacture polyvinyl chloride (PVC). In this known technique, a vinyl monomer (vinyl chloride) is polymerized in the presence of an aqueous medium, and the polymerization is stopped before all of the vinyl chloride has been polymerized. In general, the polymerization is stopped when 80 to 95% of the amount of monomer has been converted into polymer. The result of this is that the aqueous slurry of polyvinyl chloride collected after the polymerization contains an appreciable amount of residual vinyl monomer which should be removed.

Document EP 0 756 883 describes an installation which is specially designed for treating such polyvinyl chloride slurries, in order to remove therefrom the residual vinyl monomer they contain. This known installation comprises a vertical column, divided into a series of chambers on which perforated horizontal plates are superposed. After preheating the aqueous slurry to be purified to a temperature of about from 50° C. to 100° C., it is introduced into the column and flushed with an ascending stream of gas in order to extract the vinyl monomer it contains.

Vertical partitions are mounted on the perforated plates in order to form chicanes for the aqueous slurry. Due to the fact that the perforated plates must support the weight of the aqueous slurry and of the vertical partitions, these perforated plates are formed as a single part and from a considerable thickness, generally of at least 10 mm for a diameter of around 1.5 to 3.5 m. Moreover, the lower face of a perforated plate is generally designed to be smooth in order to reduce the attachment of PVC residues onto this lower face.

A stripping column according to the prior art is generally formed from several construction components, each of which comprises a perforated plate, an external wall section and vertical partitions. The assembling of several such construction components forms a vertical column comprising several chambers separated by the various plates. The construction components are assembled using clamps and comprise, between them, seals. One of the drawbacks of this construction is the risk of a sealing problem. Indeed, at the clamps, the sealing of the vertical column is compromised. Moreover, such a stripping column is costly. The maintenance of such a stripping column is also complicated and expensive. Indeed, it turns out that in order to repair a perforated plate or replace a seal, it is necessary to dismantle the stripping column, which results in the dismantling, one by one, of the construction components mounted above the location where the intervention is planned.

The object of the present invention is consequently to propose an alternative stripping column which is preferably both less expensive in terms of manufacture and maintenance.

In accordance with the invention, this objective is achieved by a stripping column for extracting a component from a liquid medium using a gas, the stripping column comprising a vertical column with an essentially cylindrical wall, the vertical column being divided by horizontal perforated plates into a series of superposed chambers, each chamber comprising several vertical partitions positioned so as to form chicanes. According to the invention, the vertical partitions are attached to the wall of the vertical column and are designed so as to hold the perforated plates.

In such a stripping column, it is no longer the perforated plate that bears the partition, but the partition that advantageously bears the perforated plate. Indeed, the load-bearing structure of the stripping column is now advantageously formed by the vertical partitions and the wall of the vertical column. These vertical partitions are attached to the wall of the vertical column in order to advantageously form the chicanes for the liquid medium to be treated. The vertical partitions are formed so as to hold, advantageously at their lower edge, a perforated plate.

The term “component” is understood to mean any component present in the liquid medium that may be extracted from this liquid medium by means of a gas. Such a component present in the liquid medium may be a gaseous compound or a liquid compound that is converted to a gaseous compound during the extraction by the gas. As examples of a component, mention may be made of ammonia, carbon dioxide, a monomer such as, for example, vinyl chloride, and also volatile organic compounds. The component is preferably carbon dioxide or a monomer such as vinyl chloride, particularly preferably a monomer and very particularly preferably vinyl chloride.

The expression “liquid medium” is understood to mean any liquid medium, whether it is aqueous or organic, that may or may not comprise solid particles. As examples of a liquid medium, mention may be made of solutions that do not comprise solid particles and suspensions (also known as slurries) that comprise solid particles. The liquid medium is preferably an aqueous liquid medium that is or is not charged with solid particles; particularly preferably an aqueous liquid medium charged with solid particles such as suspensions or slurries, very particularly preferably an aqueous polymer slurry and very particularly preferably indeed, an aqueous slurry of polyvinyl chloride.

Thus, the vertical column may be used, for example, for the debicarbonation of a carbonate/bicarbonate solution, for the purification of waters such as the wastewaters that may be reused as process waters and washing waters, or for the extraction of a monomer from an aqueous polymer slurry. Preferably, the column is used for the extraction of a monomer from an aqueous polymer slurry and particularly preferably for the extraction of vinyl chloride from a polyvinyl chloride slurry.

As examples of a gas, mention may be made of steam, air and inert gases. Steam is preferred.

The perforated plate is advantageously formed by a plurality of plate sections preferably having a width that corresponds to the distance between two vertical partitions or between a vertical partition and the wall of the vertical column. The perforated plate is therefore advantageously divided into a plurality of smaller components. Such plate sections are light, flexible and easy to manipulate into place.

The plate sections advantageously have a thickness between 2 and 8 mm, preferably around 4 mm. The thickness is advantageously less than or equal to 8 mm, preferably less than or equal to 6 mm, but advantageously greater than or equal to 2 mm. The thickness of the perforated plates is therefore reduced relative to conventional plates, which generally have a minimum thickness of 10 mm.

The vertical partition preferably has a cross section in the shape of an upside-down “T” and comprises, on its lower edge, a flange that extends on both sides of the vertical partition and that acts as support for the plate sections. The vertical partitions may thus readily receive the plate sections between them and bear these sections. A plate section advantageously rests on the flange of the vertical partition and is preferably attached thereto, for example by welding or bolting.

The perforations in the plate sections are advantageously essentially cylindrical. Perforations of cylindrical shape can be produced rapidly, which allows a rapid and less expensive manufacture of the plate sections. It should be noted that the perforations of cylindrical shape constitute a significant advantage when the number of perforations per perforated plate is considered, which may exceed 1500 perforations per m², or even 2000 perforations per m². According to the prior art, the perforations generally have a more complicated shape with two cylindrical parts of different diameter connected by a frustum of a cone. The diameter of the cylindrical part on the upper side of the plate is of the order of 1.2 mm and the diameter of the cylindrical part on the lower side of the plate is of the order of 6 mm; the angle of the cone being less than 120° and the thickness of the perforated plate of the order of 12 mm. The manufacture of such perforations requires either one special piercing tool or two separate piercing tools. Owing to the fact that the plate sections have a smaller thickness, these perforations of complex shape can be replaced by perforations of simple cylindrical shape. It should be noted that, although the perforations are preferably of cylindrical shape, it is not excluded to provide perforations having other shapes, such as for example shapes that are at least partially conical with a downwards or upwards opening.

The wall of the vertical column is advantageously formed as a single part. An assembling of several construction components in order to form the vertical column is no longer necessary. The clamps and seals between the various construction components can be eliminated. Indeed, owing to the load-bearing structure formed by the vertical partitions and the plate sections, which are more easily replacable, of the inside of the column, the dismantling of the column is not necessary in order to access the various horizontal plates, in particular due to the presence of manholes.

The vertical partitions are preferably welded to the wall of the vertical column. It is not however excluded to attach the vertical partitions to the wall of the vertical column by another means such as, for example, bolting.

Each vertical partition advantageously comprises a first end and a second end, the first end being attached to the wall of the vertical column. According to one embodiment, the second end is arranged at a certain distance from the wall of the vertical column so as to form an opening for the passage of the liquid medium. According to another preferred embodiment, the second end comprises a strut connected, on the one hand, to the vertical partition and, on the other hand, to the wall of the vertical column, the strut being designed so as to form an opening through the vertical partition.

A rinsing system, preferably a high-pressure rinsing system, is advantageously arranged in the chamber to clean the lower face of the plate sections positioned overhead. Such a rinsing system may comprise a distribution ring that is coaxial with the perforated plate, the distribution ring comprising a plurality of high-pressure nozzles positioned so that the jets emanating from the nozzles cover the entire lower face of the perforated plate. A supplementary nozzle, the jet of which is pointed at a porthole of the chamber, may be provided in order to carry out the cleaning of the porthole. Such a rinsing system makes it possible to prevent the attachment of residues, especially of PVC, onto the lower face of the perforated plate. The present rinsing system has better performance than the known rinsing systems, which are composed of concentric circular pipes with a large number of large-diameter holes.

A perforated plate advantageously comprises a discharge zone with a discharge opening allowing the flow of the liquid medium from one chamber to a subjacent chamber. According to one aspect of the invention, a barrier is positioned upstream of the discharge opening, the barrier regulating the height of the liquid medium in the chamber.

Preferably, the barrier is removably attached to a vertical partition and/or to the wall of the vertical column. The barrier may, for example, be bolted to the vertical partition and/or to the wall. Thus, the barrier can be easily dismantled and may be replaced by a barrier of a different height, therefore allowing an easy adjustment of the height of the liquid medium in a chamber. Advantageously, the barrier comprises a lower opening in order to facilitate the passage of the solid.

According to one aspect of the invention, the upper chamber comprises a liquid medium receiving zone, the receiving zone being configured so as to be able to carry out a degassing of the liquid medium in the receiving zone. When the flow of liquid medium is high, foaming takes on proportions that cause effects that are damaging to the correct operation of the process. Hence, this excessive foaming must be avoided. The foaming effect may be reduced either by reduction of the flow of liquid medium, or by degassing at the inlet to the vertical column. The degassing may be carried out, as proposed in EP 0 756 883, in a chamber that is enlarged relative to the subjacent chambers. However, the enlargement of this chamber leads to a more complicated construction of the vertical column. Another possibility for the degassing is to provide an expansion unit upstream of the inlet to the vertical column. Such an external expansion unit leads, however, to a larger space requirement and to higher costs.

The present invention proposes, however, a receiving zone in the upper chamber of the vertical column, this receiving zone being configured so as to be able to carry out a degassing of the liquid medium in this receiving zone, that is to say inside the vertical column. According to the invention, the upper chamber preferably has the same diameter as the subjacent chambers and the receiving zone may be formed by removing or modifying a first vertical partition of the upper chamber. Since the vertical partitions form the load-bearing structure for the plate sections, the first vertical partition is advantageously modified by reducing its height. A plurality of passages may be made in the first vertical partition in order to allow the liquid medium to be distributed on both sides of the first vertical partition.

The receiving zone preferably comprises plate sections with a reduced number of perforations.

The invention also relates to a stripping process for extracting a component from a liquid medium using a gas, in particular for extracting a monomer from an aqueous polymer slurry, the process using a stripping column according to the invention.

Other particularities and features of the invention will appear from the detailed description of some advantageous embodiments given below, by way of illustration, with reference to the appended drawings.

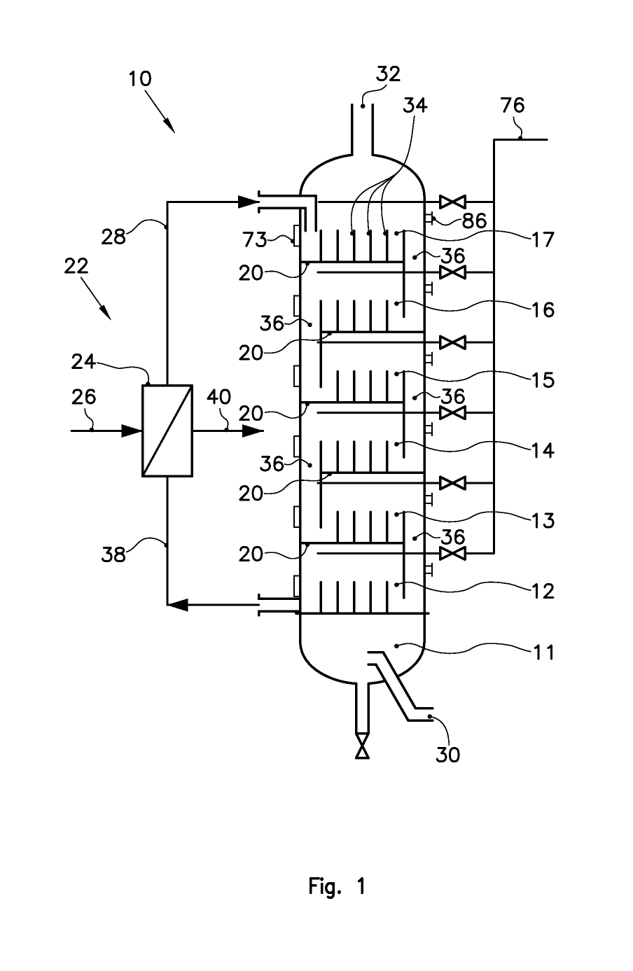

FIG. 1: is an elevation diagram of a vertical column;

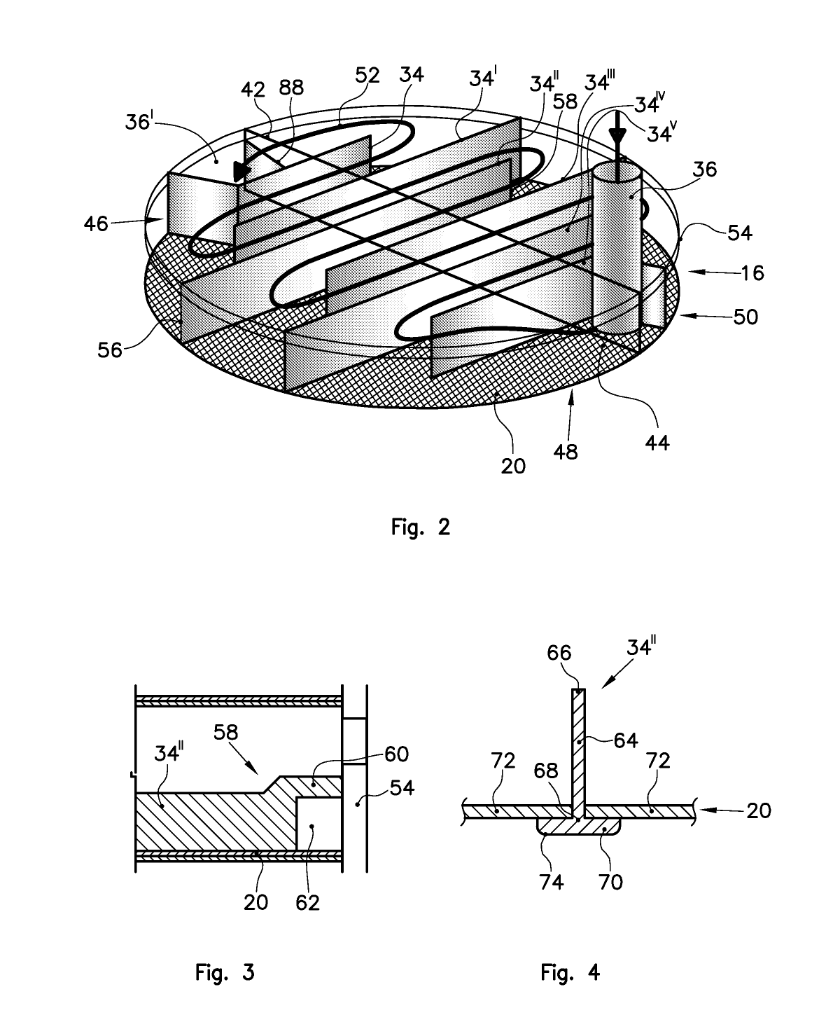

FIG. 2: is a perspective view of a chamber of the vertical column;

FIG. 3: is a front view of a second end of a vertical partition according to the invention;

FIG. 4: is a cross-sectional view through a vertical partition according to the invention;

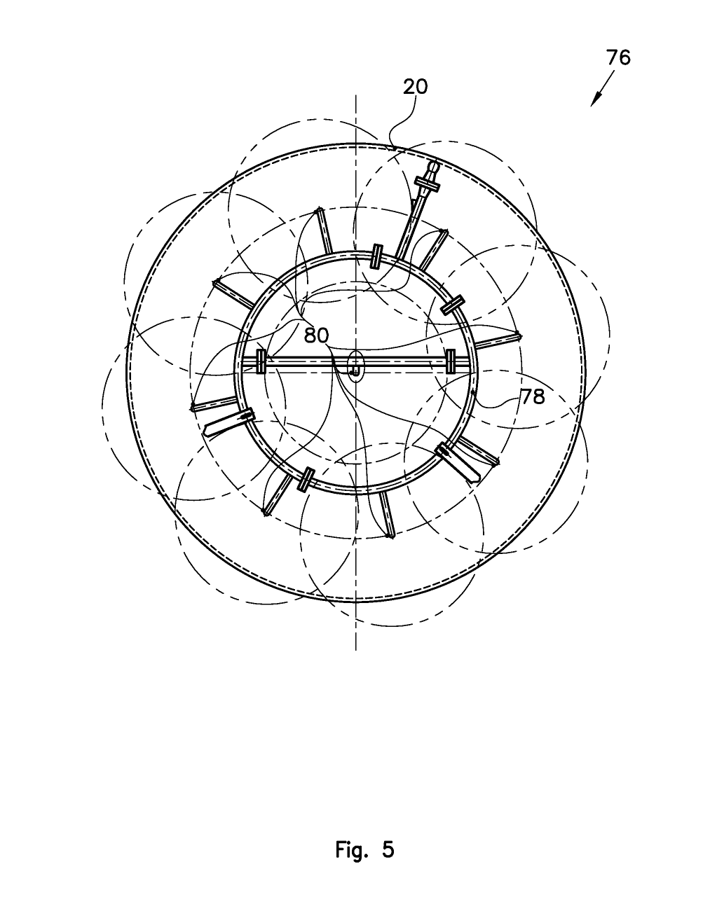

FIG. 5: is a schematic view of a rinsing system according to the invention;

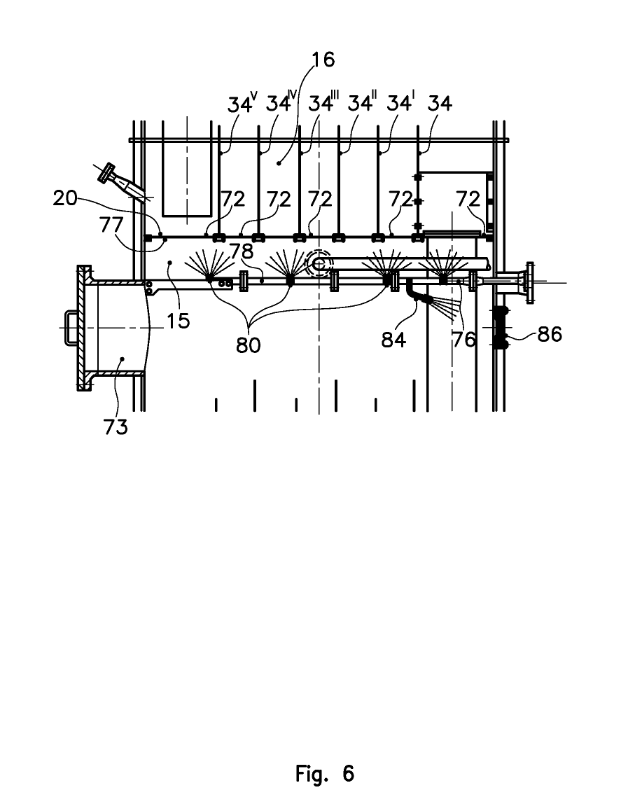

FIG. 6: is a front view of the rinsing system from FIG. 5;

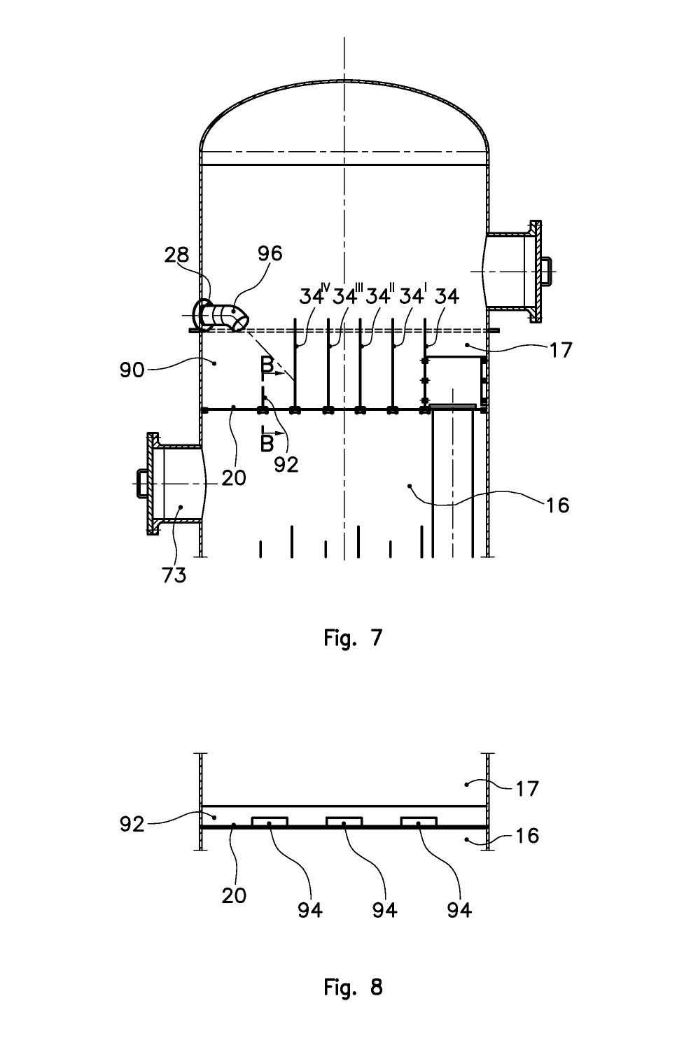

FIG. 7: is a cross-sectional view through the upper part of a vertical column according to the invention;

FIG. 8: is a front view of a partition of the vertical column from FIG. 7; and

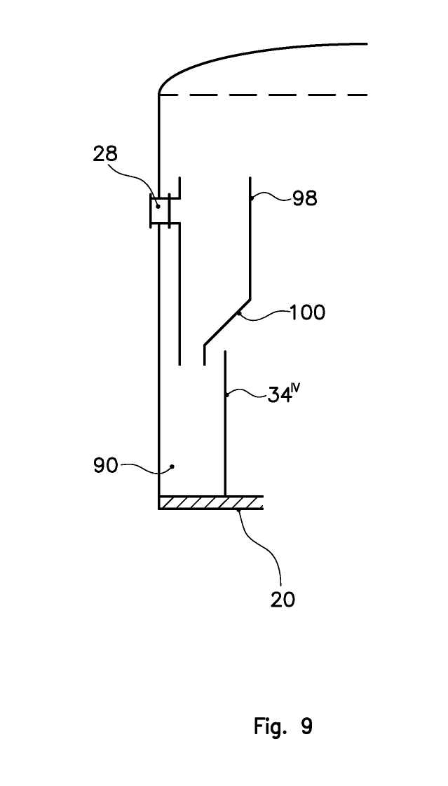

FIG. 9: is a partial cross section through the upper part of a vertical column according to the invention.

In these figures, the same reference numbers denote identical components.

The installation represented in FIG. 1 comprises a vertical column 10, divided into a succession of superposed chambers 11, 12, . . . , 16, 17, by horizontal perforated plates 20. The vertical column 10 illustrated is a column for the extraction of residual vinyl chloride from a polyvinyl chloride slurry. The upper chamber 17 of the vertical column 10 is in communication with a polyvinyl chloride slurry intake device, denoted in its entirety by the reference number 22. This intake device comprises a heater 24, a pipe 26 for introducing a slurry into the heater 24, and a feed pipe (inlet port) 28 between the heater 24 and the upper chamber 17 of the vertical column 10. A gas intake pipe 30 opens into the lower chamber 11 of the vertical column 10 and an output pipe 38 joins the chamber 12 to the heater 24. A vent 32 is provided at the top of the vertical column 10. Each chamber of the column may be equipped with manholes 73 and/or portholes 86. Details concerning the vertical column 10 and the operation thereof are available in document EP 0 756 883.

The installation is especially adapted to the treatment of polyvinyl chloride slurries obtained by the suspension polymerization technique. These slurries are contaminated with vinyl chloride which is residual from the polymerization. In this particular application of the installation, the polyvinyl chloride slurry originating from the polymerization is introduced into the heater 24 via the intake pipe 26. In the heater 24, the slurry is heated to a temperature of around 100° C. The hot slurry is transferred from the heater 24 into the upper chamber 17 of the vertical column 10 via the feed pipe (inlet port) 28.

In the upper chamber 17 of the vertical column 10, the slurry drops onto the plate 20, where it circulates in chicanes formed by a network of vertical partitions 34, before reaching an overflow 36 through which it drops in order to reach the plate 20 of the subjacent chamber 16 of the vertical column 10. In this way the slurry gradually descends through the vertical column 10, to the chamber 12. While it flows from top to bottom through the vertical column 10, the slurry is flushed with an ascending stream of gas which is introduced into the bottom of the column via the pipe 30. The result of flushing the slurry with the gas stream is that the vinyl chloride present in the slurry is extracted and entrained to the top of the vertical column 10. The gas charged with vinyl chloride is discharged from the headspace of the vertical column 10 via the vent 32. The slurry which reaches the chamber 12 is substantially free of vinyl chloride and it is hot. It is discharged from the vertical column 10 via an outlet pipe 38 and is introduced into the heater 24 where its sensible heat is used to heat the slurry which enters therein via the pipe 26. The slurry cooled in the heater 24 exits this heater via an extraction pipe 40. Details concerning the circulation and treatment of the slurry in the vertical column 10 are available in document EP 0 756 883.

A chamber, for example the chamber 16, is shown in greater detail in FIG. 2, illustrating in particular the arrangement of the vertical partitions 34.

FIG. 2 shows a vertical plane 42, crossing the centre of the chamber 16 and going from an inlet zone 44, which receives, through an overflow 36, the aqueous slurry originating from a superjacent chamber 17, to an outlet zone 46, which discharges, through an overflow 36′, the aqueous slurry to a subjacent chamber 15. This vertical plane 42 divides the chamber 16 into a first half 48 and a second half 50. A plurality of vertical partitions 34, 34^{I}, 34^{II}, 34^{III}, 34^{IV}, 34^{V} are arranged essentially perpendicular to the vertical plane 42. The vertical partitions 34, 34^{I}, 34^{II}, 34^{III}, 34^{IV}, 34^{V} form chicanes that drive the aqueous slurry from the inlet zone 44 to the outlet zone 46; the flow of the aqueous slurry, generally represented by the arrow 52, being generally perpendicular to the vertical plane 42, except in the marginal zones of the chamber 16.

According to one important aspect of the invention, the vertical partitions 34 are attached to the wall 54 of the vertical column 10. The vertical partitions 34, 34^{I}, 34^{II}, 34^{III}, 34^{IV}, 34^{V} have, each time, a first end connected to the wall 54 of the vertical column 10, alternately in the first or second half 48, 50 of the chamber 16. Thus, for example, the vertical partition 34^{II} comprises a first end 56 connected to the wall 54 in the first half 48 of the chamber 16 and a second end 58 in the second half 50 of the chamber 16. The various vertical partitions 34, 34^{I}, 34^{II}, 34^{III}, 34^{IV}, 34^{V} are essentially parallel to one another and perpendicular to the vertical plane 42.

The second end 58 may be, as illustrated in FIG. 2, arranged at a certain distance from the wall 54 thus allowing the passage of the aqueous slurry. Preferably, on the other hand, the second end 58 is attached to the wall 54 and comprises an opening that allows the passage of the aqueous slurry. This preferred embodiment is illustrated in FIG. 3, which shows, on a large scale, the second end 58 of the vertical partition 34^{II}. A strut 60 is provided between the vertical partition 34^{II} and the wall 54 thus allowing the second end 58 to be attached to the wall 54, while creating an opening 62 for the passage of the aqueous slurry through the vertical partition 34^{II}.

FIG. 4 shows a cross section through a vertical partition 34^{II} in the shape of an upside-down “T”, comprising a vertical portion 64 with an upper edge 66 and a lower edge 68. The lower edge 68 comprises a flange 70 that extends on both sides of the vertical portion 64 and that acts as support for the horizontal perforated plate 20. Indeed, the horizontal perforated plate 20 is formed by a plurality of plate sections 72, in strip form. The plate sections 72 have a width that corresponds to the distance between two neighbouring vertical partitions 34, 34^{I}, 34^{II}, 34^{III}, 34^{IV}, 34^{V}, respectively between a vertical partition 34, 34^{V} and the wall 54. These plates sections 72 rest on the flange 70 of the vertical partitions and are attached thereto, for example by welding or bolting. The lower face 74 of the flange 70 is rounded at the corners in order to limit the points of attachment on the lower face of the perforated plate 20. As an alternative to the above solution, it is not excluded to provide a vertical partition having a cross section in the shape of an upside-down “T”, comprising a vertical portion with a flange at the lower edge; the flange being configured in order to receive the plate sections against its lower face, the plate sections being attached to the flange by bolting or welding. However, this solution creates, at the junctions between two plate sections, a hollow in the lower face of the perforated plate. Another alternative is to provide a flange with a shoulder and plate sections with corresponding shoulders, the assembling of the plate sections to the flanges taking place at the shoulders.

Since the load-bearing structure is formed by the vertical partitions 34, 34^{I}, 34^{II}, 34^{III}, 34^{IV}, 34^{V} attached to the wall 54 of the vertical column 10, the plate sections 72 may be of lower strength relative to the known installations in which the load-bearing structure is formed by the horizontal perforated plate. Therefore, the thickness of a plate section 72 may be from 2 to 8 mm. Such plate sections 72 have a certain flexibility and may be easily manipulated into place, for example through a manhole 73, in order, for example, to replace a damaged plate section. This replacement may be carried out from inside the vertical column 10, which therefore does not require the vertical column to be dismantled as is the case for the columns according to the prior art. It also ensues therefrom that the vertical column 10 can be constructed with one wall covering the entire height of the vertical column, that is to say without resorting to an assembling of several construction components. The clamps and seals between the various construction components no longer have an essential purpose and the leakage problems at these locations are therefore prevented.

According to another aspect of the invention, a rinsing system 76 is provided underneath the horizontal perforated plate 20 in order to clean the lower face 77 of this perforated plate 20. Such a rinsing system 76 is schematically represented in FIGS. 5 and 6. The rinsing system 76 according to the invention comprises a distribution ring 78, which is coaxial with the perforated plate 20, the distribution ring 78 comprising a plurality of nozzles 80, preferably high-pressure nozzles, positioned so that the jets emanating from the nozzles 80 cover the entire lower face 77 of the perforated plate 20. If the vertical column is equipped with portholes 86, a supplementary nozzle 84, the jet of which is pointed at a porthole 86 of the chamber 15, may be provided in order to carry out the cleaning of the porthole 86. Such a rinsing system 76 has better performance than the known system, which is composed of concentric circular pipes with a large number of holes, but which does not uniformly spray the entire lower face 77.

A barrier 88 (FIG. 2) is generally provided upstream of the overflow allowing the aqueous slurry to pass from one chamber to a subjacent chamber. The height of the barrier 88 defines the height of the aqueous slurry on the perforated plate. According to one aspect of the invention, the barrier 88 is bolted to the vertical partition 34 and/or to the wall 54, thus allowing it to be easily dismantled and replaced by a barrier of a different height. The height of the aqueous slurry on the perforated plate may thus be easily adjusted.

According to another aspect of the invention, the vertical column 10 comprises a degassing zone in order to enable gas-liquid separation. When the flow of aqueous slurry is high, such a foaming takes on proportions that cause effects that are damaging to the correct operation of the process. Hence, this excessive foaming must be avoided. The foaming effect may be reduced either by reduction of the flow of aqueous slurry, or by degassing at the inlet to the vertical column 10. The degassing may be carried out in an upper chamber that is enlarged relative to the subjacent chambers. However, the enlargement of the upper chamber leads to a more complicated construction of the vertical column. Another possibility for the degassing is to provide an external expansion unit upstream of the inlet to the vertical column.

Thus, as illustrated in FIG. 7, the present invention therefore proposes a receiving zone 90 in an upper chamber 17 of the vertical column, the chamber 17 having the same diameter as the subjacent chambers 11, 12, . . . , 16. The receiving zone 90 is adapted in order to enable the degassing of the aqueous slurry. The receiving zone 90 may be formed by an enlargement of the part of the perforated plate that receives the aqueous slurry from the feed pipe (inlet port) 28. This enlargement of the receiving zone may be obtained by removing or modifying the first vertical partition 92 of the upper chamber 17 and optionally of one or more subjacent chambers. Since the vertical partitions form the load-bearing structure for the plate sections 72, the first vertical partition 92 is advantageously modified by reducing its height. The first vertical partition 92 can be described in greater detail by referring to FIG. 8, which shows a cross section through the section B-B from FIG. 7. A plurality of passages 94 are made in the first vertical partition 92, in order to allow the aqueous slurry to be distributed on both sides of the first vertical partition 92. The passages 94 also serve to reduce the accumulation of solids in the receiving zone 90.

To reduce the foaming effect, the plate sections 72 in the receiving zone 90 are provided with a reduced number of perforations, thus limiting the evaporation of the monomer with the gas.

The feed pipe (inlet port) 28 enters, as shown in FIG. 7, into the upper chamber 17 and comprises a bend 96 that directs the flow of aqueous slurry into the receiving zone 90. Preferably, the feed pipe (inlet port) 28 is arranged so as to create turbulence of the aqueous slurry in the receiving zone 90.

According to another embodiment, illustrated in FIG. 9, a deflector 98 is provided downstream of the inlet of aqueous slurry into the upper chamber 17. The deflector 98 is designed to break up the flow of the jet of aqueous slurry entering into the upper chamber 17 from the feed pipe (inlet port) 28 and to direct the aqueous slurry into the receiving zone 90. For this purpose, the deflector 98 comprises a part 100 that forms a funnel (cyclone), which part may also comprise means for creating turbulence of the aqueous slurry arriving in the receiving zone 90. It should be noted that the removal or modification of the first vertical partition 92, the turbulence of the aqueous slurry and the deflector 98 are elements which may be used alone or in combination.

1. A stripping column for extracting a component from a liquid medium using a gas, the stripping column comprising:
a vertical column comprising an essentially cylindrical wall, the vertical column being divided by horizontal perforated plates into a series of superposed chambers, each chamber comprising several vertical partitions positioned so as to form chicanes;
wherein
the vertical partitions are attached to the wall of the vertical column and are designed so as to hold the perforated plates.

2. The stripping column according to claim 1, wherein the perforated plates are formed by a plurality of plate sections.

3. The stripping column according to claim 2, wherein the plate sections have a thickness between 2 and 8 mm.

4. The stripping column according to claim 2, wherein a vertical partition has a cross section in the shape of an upside-down “T”, comprising, on its lower edge, a flange that extends on both sides of the vertical partition and that acts as support for the plate sections.

5. The stripping column according to claim 2, wherein the perforations in the plate sections are essentially cylindrical.

6. The stripping column according to claim 1, wherein the wall of the vertical column is formed as a single part.

7. The stripping column according to claim 1, wherein the vertical partitions are welded to the wall of the vertical column.

8. The stripping column according to claim 1, wherein each vertical partition comprises a first end and a second end, wherein the first end is attached to the wall of the vertical column, and wherein the second end is arranged at a certain distance from the wall of the vertical column so as to form an opening for the passage of a liquid medium.

9. The stripping column according to claim 1, wherein each vertical partition comprising a first end and a second end, wherein the first end is attached to the wall of the vertical column, and wherein the second end comprises a strut connected, on the one hand, to the vertical partition and, on the other hand, to the wall of the vertical column, the stmt being designed so as to form an opening through the vertical partition.

10. The stripping column according to claim 1, wherein a rinsing system is arranged in a chamber to clean the lower face of the perforated plate positioned overhead.

11. The stripping column according to claim 1, wherein a perforated plate comprises a discharge zone with a discharge opening allowing the flow of a liquid medium from one chamber to a subjacent chamber, a barrier being positioned upstream of the discharge opening, the barrier regulating the height of the liquid medium in the chamber.

12. The stripping column according to claim 11, wherein the barrier is removably attached to a vertical partition and/or to the wall of the vertical column.

13. The stripping column according to claim 1, wherein one of the chambers in the vertical column is an upper chamber which comprises a liquid medium receiving zone, the receiving zone being configured so as to be able to carry out a degassing of a liquid medium in the receiving zone.

14. The stripping column according to claim 13, wherein the receiving zone comprises plate sections with a reduced number of perforations.

15. A stripping process for extracting a component from a liquid medium using a gas, comprising using the stripping column according to claim 1.
